(19) United States
(12) Patent Application Publication
(10) Pub. No.: US 2008/0008945 A1
(43) Pub. Date: Jan. 10, 2008

(54) TONER, TONER PRODUCING METHOD AND IMAGE FORMING METHOD

(75) Inventors: Kenichi ONAKA, Tokyo (JP); Masahiko NAKAMURA, Tokyo (JP); Kaori SOEDA, Tokyo (JP); Tomoko MINE, Tokyo (JP); Eiichi YOSHIDA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/764,883

(22) Filed: Jun. 19, 2007

(30) Foreign Application Priority Data
Jul. 4, 2006 (JP) 2006184215

(51) Int. Cl. G03G 9/00; G03G 13/04; G03G 5/00

(52) U.S. Cl. 430/48; 430/108.3; 430/108.4; 430/137.15

(57) ABSTRACT

A toner is disclosed. The toner comprises a vinyl resin, a colorant, and a compound represented by a formula of Compound 1, Compound 2 ion or Compound 3.

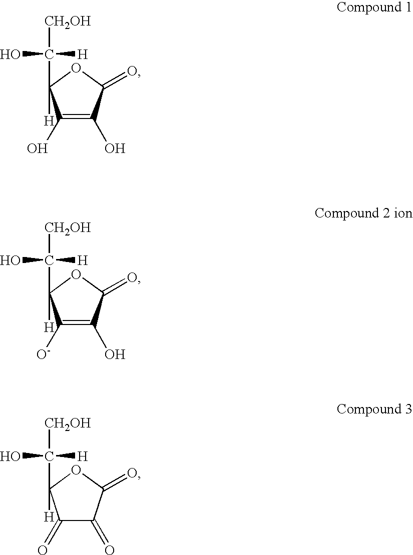

This application is based on Japanese Patent Application No. 2006-184215 filed on Jul. 4, 2006, in Japanese Patent Office, the entire content of which is hereby incorporated by reference.

### TECHNICAL FIELD

The present invention relates to a toner for forming image by electrophotographic system such as printers and copy machines.

### TECHNICAL BACKGROUND

Recently, electrophotographic color image forming apparatuses such as printers and multi-functional image forming machine are considerably spread and research and development for making compact and light weight and reducing the cost of such the apparatuses have been positively progressed. Furthermore, new technological development such as low temperature fixing tends to be more accelerated from the viewpoint of environmental correspondence such as reducing of exhaust amount of carbon dioxide gas and lowering of print cost.

Besides, investigation for raising the color reproduction ability of color images is performed since more clearly and plentiful color reproduction is required by customers to the quality of printed color images. As one of such the development, a technique is known in which an antioxidant is added to toner for raising the weatherproof ability of the colorant contained in the toner; cf. Patent Document 1, for example.

In this technology, it is intended to raise the color reproducibility by improving the dispersing state of the colorant in the toner particle by adding a hindered phenol compound and selecting a specific cyan colorant.

A method in which ascorbic acid, one kind of antioxidant, is added onto toner particles is disclosed; cf. Patent Documents 2 and 3, for example.

Patent Document 1: Tokkai Hei 1-173061

Patent Document 2: Tokkai 2005-297550

Patent Document 3: Tokkai 2001-5221

### SUMMARY OF THE INVENTION

However, production of color images on the level satisfying the customers by the former technology e accompanies difficulty even though technology for improving the color reproducibility of color image has be investigated as above-described. For instance, when a toner was prepared according to the conditions described in the foregoing patent documents, it was very difficult to form cyan images with color reproducibility. Contaminated color images were obtained when the images were formed by a toner prepared according to the technology disclosed in the foregoing patent documents, particularly any printed image with clear tone could be difficultly formed by a toner using a colorant containing a copper atom was used. Moreover, occurrence of odor on the occasion of fixing was recognized; it was supposed that the odor caused by increasing in the using amount of the toner.

On the above-described background, an object of the invention is to provide an electrophotographic color image having clear tone without contamination. Another object of the invention is to provide an image forming method capable of comfortably forming a print without occurrence of odor.

One aspect of the invention is:

A toner comprising a vinyl type resin and a colorant, wherein the toner contains at least one of Compound 1, Compound 2 ion and Compound 3.

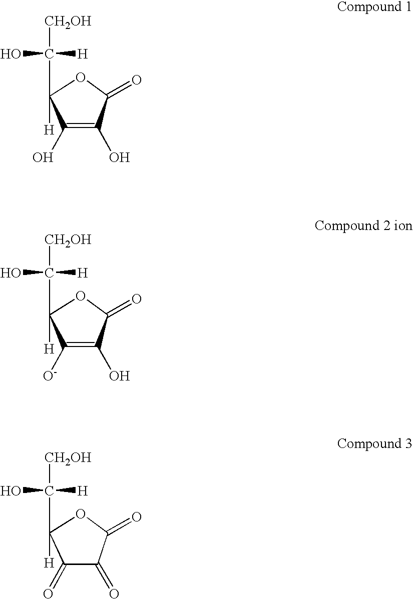

The total amount of the compounds is preferably from 10 to 140 ppm.

The colorant preferably contains a copper atom in one embodiment.

The toner can be prepared by a method in which at least one of the following compounds and an inorganic peroxide compound as the polymerization initiator are used on the occasion of preparing the vinyl type resin.

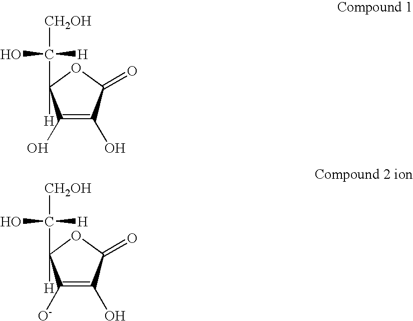

A preferable example of the inorganic peroxide compound is hydrogen peroxide.

### BRIEF DESCRIPTION OF THE DRAWINGS

FIG. 1 shows a schematic cross section of an example of non-magnetic single-component type developing device.

FIG. 2 shows a schematic cross section of an example of full-color image forming apparatus for image formation using the toner of the invention.

### DESCRIPTION OF THE INVENTION

Formation of color images having clear color reproducibility without contamination can be made possible by the invention. Particularly, the clear color image without color contamination can be surly formed by the toner containing a copper atom, by which clear color reproduction is difficult by the former technology. Moreover, the odor is not caused on the occasion of fixing so that the comfortable image formation condition can be provided.

### THE BEST EMBODIMENT FOR EMBODYING THE INVENTION

Formation of the image having high chromaticity can be carried out by the toner of the invention. The reason of that such the toner having high color reproducibility can be obtained is not cleared yet. It is supposed that such the effect is caused by the considerably strong anti-oxidizing effect of the above compounds and the electron distribution in the compound which difficultly forms specific complex with the copper atom. The materials such as the photoreceptor and the toner are frequently exposed to a reactive substance such as ozone in the course of the image formation by the electrophotographic system. In such the situation, the compound is oxidized earlier than others by the reactive substance so as that the properties of the material such as the photoreceptor and the toner are maintained. As a result of that, it is supposed that the original chromaticity of the colorant in the toner can be appeared and the clear color image can be realized.

Formation of color images having clear color reproducibility without contamination can be made possible by the invention. Particularly, the clear color image without color contamination can be surly formed by the toner containing the copper atom, by which clear color reproduction is difficult by the former technology. Clear color reproduction of secondary colored formed by plural color toners is also made possible.

The odor occurrence accompanied with fixing is disappeared by the use of the toner of the invention; the reason of such the effect is supposed that the above compound decomposes the substance causing the odor in the toner or quenches the thermal decomposed substance formed on the occasion of fixing.

Furthermore, the lowering in the image density in the course of continuous printing under low temperature and low humidity condition can be inhibited by the use of the toner of the invention, and it is confirmed that the problem of excessive charging under the low temperature and low humidity condition is solved.

The invention is decribed in detail below.

The toner of the invention at least contains a vinyl type resin and at least one of a colorant in which Compound 1, an Compound 2 ion and Compound 3 each having the following structure.

Compounds 1, Compound 2 ion and Compound 3 are shown below.

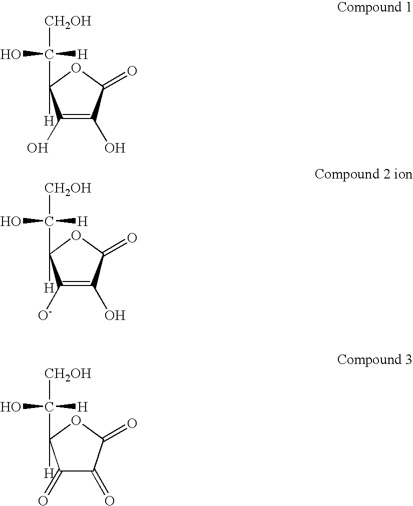

For the metal salt of Compound 2 ion, a mono-valent alkali metal such as lithium, sodium and potassium are applicable.

The total amount of Compound 1, the Compound 2 ion and Compound 3 contained in the toner is preferable from 10 to 140 ppm.

It is supposed that the influence of the reactive substance such as ozone on the toner constituting materials such the resin and the colorant can be avoided by accepting the influence of the reactive substance by only these compounds when the total amount of Compound 1, the Compound 2 ion and Compound 3 is within the range of from 10 to 140 ppm. The influence of the oxidation effect of the compound onto the durability of the toner particle or the charging property of the toner is avoided by making the total mount of Compound 1, the Compound 2 ion and Compound 3 into the above range.

A polymerization initiator is used for producing the vinyl type resin, and the polymerization and an inorganic peroxide. As the inorganic peroxide, for example, hydrogen peroxide, potassium persulfate and potassium peroxide (K₂O₂) are usable and hydrogen peroxide is preferred among them.

Compound 1, the Compound 2 ion and Compound 3 contained in the toner can be measured by the following procedure.

Analyzing Method for Compound 1, Compound 2 Ion and Compound 3

Compound 1, the Compound 2 ion and Compound 3 are extracted by methanol and hydrochloric acid from the toner as substances having lower molecular weight. The resultant extract was subjected to, for example, hydrophilic interaction chromatography for detecting chromatographic peaks. The component of each of the peaks can be analyzed by identified by a usual method. The usual method is the identification method by an apparatus for identifying the structure of organic compound such as nuclear magnetic resonance (NMR) spectrum, gas chromatography and mass spectrograph, and such the apparatus also may be applied.

The hydrophilic interaction chromatography (HILIC) is a kind of normal phase chromatography using a mixed solvent of an organic solvent and water or a buffer solution is used as the mobile phase, which is suitable for analyzing a polar sample.

By the hydrophilic interaction chromatography, polar compounds such as Compound 1, the Compound 2 ion and Compound 3 can be analyzed because the polarity of the mobile phase can be raised by the use of the mixed solvent of the organic solvent and water or the buffer solution. Namely, the contents of the sample can be separated by controlling the organic solvent concentration since the polarity of the fixed phase is higher than that of the mobile phase so that the polar substance can be analyzed by water in the mobile phase.

The detailed mechanism of the hydrophilic interaction chromatography is described in, for example, “Hydrophilic Interaction Chromatography”, Technical Report No. 018, Nomura Chemical Co., Ltd.

The measuring conditions for Compound 1, the Compound 2 ion and Compound 3 are as follows.

Column: ZIC-HILIC (5 μm) 4.6×150 mm

Mobile phase: A mixed solvent of acetonitrile and 50 mM ammonium acetate aqueous solution in a ratio of 80/20

Flowing rate: 0.8 ml/minute

Temperature: 30° C.

Detecting means: UV ray of 254 nm

As a result of measuring the toner of the invention under the above conditions, at least one of peaks of Compound 1, the Compound 2 ion and Compound 3 was obtained at a holding time of about 9 minutes. Of course, the structure of the compound should be confirmed by the separated liquid.

The compound is separated by the hydrophilic interaction chromatography and identified by deciding the structure of the separated substance by the method such as the mass spectrum analysis or the nuclear magnetic resonance analysis.

The quantity of the compound is calculated from the peak area ratio according to a calibration curve prepared by using a standard reagent available on the market which has the same structure as the compound using in the invention.

Compound 1, the Compound 2 ion and Compound 3 are extracted from the toner by adding 20 ml of a methanol solution containing 1N—HCl to 1 g of the toner and subjecting to ultrasonic treatment.

The resultant extract is diluted by 10 times of purified water and filtered by a chromato-disc to prepare a sample for measurement which is subjected to HILIC analysis.

In the above, the extraction method using the methanol solution containing 1N—HCl is described, but the method is not limited to it. Acetone can be used for the liquid for extraction.

The toner of the invention contains at least one of Compound 1, Compound 2 ion and Compound 3 and it is not essential to entirely contain these compounds. For instance, cases other than the case in which all of Compound 1, the Compound 2 ion and Compound 3 are contained such as a case in which Compound 1 and Compound 3 are contained and Compound 2 ion is not contained, a case in which Compound 1 is only contained and the other compounds are not contained, and a case in which Compound 3 is only contained and the other compounds are not contained are included.

The physical properties of the toner of the invention are described below.

Median Diameter D₅₀ on Volume Base

The median diameter D₅₀ of the toner of the invention on the volume base is preferably from 3 to 9 μm from the viewpoint of image quality, developing ability (image density) and fixing ability.

The median diameter D₅₉ on volume base and the variation coefficient of particle size distribution on volume base can be measured and calculated by using Multisizer 3, manufactured by Beckman Coulter Co., Ltd., connected with a data processing computer manufactured by Beckman Coulter Co., Ltd.

In the measuring procedure, 0.02 g of the toner is wetted by 20 ml of a surfactant solution, for example, a surfactant solution prepared by diluting a neutral detergent containing s surfactant component by 10 times by purified water for dispersing the toner, and then dispersed by ultrasonic waves for 1 minutes to prepare a toner dispersion. The toner dispersion is injected by a pipette into a beaker containing Isoton II, manufactured by Beckman Coulter Co., Ltd., previously set in the sample stand until the concentration of the sample becomes the measuring concentration of 8% by weight. The counter of the measuring apparatus is set at 2500 for measurement. The aperture diameter of Multisizer is set at 50 μm.

Variation Coefficient of Particle Size Distribution on Volume Base

The variation coefficient of particle size distribution on volume base is preferably from 8 to 21% and more preferably from 10 to 19%.

The variation coefficient of particle size distribution on volume base is calculated by the following expression.

Variation coefficient of particle size distribution on volume base (%)=(S₂/Dn)×100.

In the above, S₂ is the standard deviation of the particle size distribution on volume base and Dn is the median diameter D₅₀ on volume base.

Average Circular Degree

The circular degree of the toner of the invention is preferably from 0.941 to 0.995, more preferably 0.951 to 0.990.

The circular degree of the toner is defined by the following expression.

Circular degree=(Circumference length of a cycle having the same projection area as the particle image)/(Circumference length of the projection image of the particle)

The average circular degree is a value of quotient of the sum of the circular degree of each of the particles by the total number of the particle.

The circular degree of the toner is a value measured by FPIA-2100, manufactured by Sysmex Corporation. In concrete, the toner was wetted by a solution containing a surfactant and subjected to ultrasonic treatment for 1 minute, and then measured by FPIA-2100. For the measurement, the apparatus is set at a HPF (high amplitude image taking) mode and the concentration is controlled so that the HFP detecting number of the particles is to be within the range of from 3,000 to 10,000.

Producing Method of the Toner

The method for producing the toner comprises a step for forming the resin and a step for forming colored particles from the obtained resin and the colorant, and the compound represented by Formula 1 or compound 2 ion and the inorganic peroxide are used as the polymerization initiators in the step of preparation of the resin.

The producing method for the toner of the invention is preferably a method comprising a step of forming resin particles by emulsion polymerization and a step of coagulating the resin particles to form the toner.

A preferable example of the method comprising the step of coagulating the resin particles is described in detail below.

The toner is produced by the following processes in the toner production method relating to the invention. The toner producing method of the invention includes (1) a polymerization process for polymerizing a polymerizable monomer to prepare a resin particle dispersion, (2) a coagulation process for forming intermediate toner particles functioning as a mother body of the toner by coagulating toner constituting components such as the resin particles and the colorant, hereinafter referred to as resin particle coagulation step, (3) a toner shape controlling process for finishing the fusion of the materials constituting the intermediate toner particle and controlling the shape of the toner particle by heating and stirring continued to the resin particle coagulation process, (4) a solid-liquid separation and washing process for separating the formed intermediate toner particles from the aqueous medium and washing the surface of the intermediate toner particle, (5) a drying process for drying the intermediate toner particles after treatment of the solid-liquid separation and washing, and (6) an external additive addition process for adding an external additive to the intermediate toner particles to prepare a toner usable for image formation.

Each of the processes is described in detail below.

Polymerization Process

In a suitable example of the polymerization, a radical polymerizable monomer solution is added to an aqueous medium containing a surfactant and droplets of the polymer are formed by adding mechanical energy and then polymerization reaction is progressed in the droplet by adding a Compound 1 and/or Compound 2 ion and the inorganic peroxide, typically hydrogen peroxide. Resin particle may be previously added to the aqueous medium as nuclei particles.

The total amount of Compound 1 and Compound 2 ion is used in an amount of 0.5 to 5 parts by weight, preferably 1.5 to 3.5 parts by weight in terms of the 100 parts by weight of the radical polymerizable monomer. The radical polymerizable monomer of 100 parts by weight is mixed with 20 to 200 parts by weight of the aqueous medium, and then Compound 1 and/or Compound 2 ion are added thereto in the polymerization process. The Compound 1 or Compound 2 ion is used as 2 to 8% by weight aqueous solution in this instance.

As for the Compound 2 ion, the compound represented by the formula of

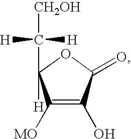

wherein M is lithium, sodium or potassium, is used. The compound is dissociated to form an ion in the aqueous solution. The amount is considered as the dissociated ion.

The mixing ratio of Compound 1 and/or Compound 2 ion to the inorganic peroxide such as hydrogen peroxide is about 2 of the inorganic peroxide to 1 to 1.2 of Compound 1 and/or Compound 2 ion.

As the inorganic peroxide to be used together with Compound 1 or Compound 2 ion, hydrogen peroxide, potassium persulfate and potassium peroxide (K₂O₂) and hydrogen peroxide is preferred among them.

In the polymerization process, it is preferable to control the molecular weight distribution at several steps by varying the amount of a chain-transfer agent. The resin particles can be obtained by such the polymerization process.

The rein particle may contain a parting agent (wax) or the colorant. Colored particle can be obtained by polymerizing a monomer composition containing the colorant.

When the non-colored resin particle is used, a colorant particle dispersion is added to the resin particle dispersion and coagulated with the resin particles to form the intermediate toner particles (mother body of toner) in the later-mentioned coagulating process.

Process for Coagulating Resin Particles

This process corresponds to “the process for coagulating the resin particles and growing the particles in an aqueous medium”.

In the process, the resin particles are coagulated with the toner constituting materials such as colorant particles to form the intermediate toner particles which are the particles before being provided the functions as the toner by the final treatment such as addition of an external additive and are also referred to as the mother body of toner or the colored particle. In the process, fusion of the coagulated particles for strongly combining the coagulated particles with together by the effect of heating is simultaneously performed with the coagulation of the particles.

The fusion of the resin particles and the colorant is preferably performed together with their coagulation. The fusion may be performed at a time by heating after the completion of the coagulation.

Concretely, the electrostatic repulsion force between particles such as the resin particle and the colorant particle are weakened by adding a di- or tri-valent salt into the aqueous medium. As a result of that, the coagulation of the particles is made possible so that the particles are coagulated with together and grown to form the intermediate toner particles. Coagulated particles are combined and fused by heating. Thus formation and growing of the intermediate toner particles are carried out.

The process for coagulating the resin particles is further described. In the process for coagulating the resin particles, the resin particles prepared by the polymerization process and the colorant particles are coagulated and the coagulated particles are simultaneously fused under a temperature condition of not less than the glass transition point of the resin particle.

For coagulating the particles, a method can be applied, in which the resin particle dispersion and the colorant particle dispersion are mixed at a temperature less than the glass transition point of the resin particle and the temperature is raised while progressing the coagulation for fusing the coagulated particles so that the coagulation and fusion of the particles are simultaneously carried out. Such the method has a merit that the shape of the particles and the particle diameter distribution are easily and uniformly controlled since the fusion of the particles can be performed while growing the particles.

From such the viewpoint, a method so-called as “salting/fusion method” is preferably applied for the process for coagulating the resin particles, in which the coagulation and the fusion are simultaneously progressed for growing particles until designated diameter and heating is continued according to necessity for controlling the shape of the particles.

The term of the aqueous medium is a medium principally composed of water (not less than 50% by weight). As the component other than water, a water compatible organic solvent such as methanol, ethanol, isopropanol, isopropanol, butanol and acetone is usable.

The coagulation of the particles is accelerated by the addition of a metal salt such as a divalent metal salt and others. Examples of the metal salt capable of accelerating the coagulation include a salt of mono-valent alkali metal such as sodium, potassium and lithium, a salt of di-valent metal such as calcium, magnesium, manganese and copper and a salt of tri-valent metal such as aluminum and iron. Concretely, sodium chloride, potassium chloride, lithium chloride, calcium chloride, magnesium chloride, zinc chloride, cupric sulfate, magnesium sulfate and manganese sulfate can be cited. These salts may be used singly or in combination of two or more kinds of them.

Among the above metal salts, the di-valent metal salts are particularly preferred since the coagulation can be progressed by small adding amount of the salt.

Such the metal salt is preferably added so that the concentration of the metal salt in the aqueous medium becomes higher than the critical coagulation concentration, concretely not less than 1.2 times and more preferably not less than 1.5 times of the critical coagulation concentration. The “critical coagulation concentration” is an indicator relating to the stability of an aqueous dispersion. The critical coagulation concentration can be calculated in detail according to the method described in S. Okamura et al, “Koubunshi Kagaku (Polymer Chemistry)” vol. 17, p. 106, edited by The Society of Polymer Science, Japan 1960. Moreover, the critical coagulation concentration can be determined by adding a designated salt in various concentrations in the dispersion to be coagulated and measuring the ζ-potential. The critical coagulation concentration is calculated from the salt concentration at which the ζ-potential is varied.

A toner constituting material such as wax, a fixation assisting agent and a charge controlling agent can be coagulated together with the resin particles and the colorant particles in the process for coagulating the resin particles.

Particle Shape Controlling Process

In the toner production method of the invention, heating and stirring are continued after the above-mentioned process for coagulating the resin particles for controlling the shape of the intermediate toner particles (mother bodies of toner). The shape of the intermediate toner particles (mother bodied of toner) can be neared sphere.

Solid-Liquid Separation and Washing Process

In the solid-liquid separation and washing process, the a solid-liquid separation treatment for separating the intermediate toner particles (mother bodies of toner) from the dispersion of the intermediate toner particles and a washing treatment for removing unnecessary substance such as the surfactant and the salting agent from the toner cake separated from the dispersion (a cake-shaped mass of the intermediate toner particles (mother bodies of toner) in a wetted state) are performed.

In the washing treatment, the cake is washed by water until the electroconductivity of the filtrate becomes 15 μS/cm.

As the method for the solid-liquid separation treatment and the washing treatment, a centrifugal method, a reduce pressure filtering method using a Buchner's funnel and a method using a filter press are applicable though the method is not specifically limited.

Drying Process

The drying process is a process for drying the washed intermediate toner particles. In the drying process, the intermediate toner particles are dried usually in the state of the cake. As the drying machine to be used in the drying process, a spray dryer, a vacuum freeze dryer and a reducing pressure dryer are usable, and a standing rack dryer, a moving rack dryer, a fluidized bed dryer, a rotary dryer and a stirring dryer are preferably used. The moisture in the dried intermediate tone particles is preferably not more than 5% and more preferably not more than 2%. When the dried intermediate toner particles (mother bodies of toner) are weakly aggregated by the inter-particle force, the aggregates may be subjected to a crushing treatment. As the crushing means, a mechanical crushing apparatus such as a jet mill, a Henschel mixer, a coffee mill and a food processor can be applied.

External Additive Adding Process

This process is a process for mixing an additive with the dried intermediate toner particles (mother bodies of toner) to produced the toner capable of being used to image formation.

As the external additive mixing means, a mechanical mixing apparatus such as a Henschel mixer and a coffee mill can be applied.

The materials to be used in the invention are described below.

Binder Resin

The vinyl type resin constituting the resin particle preferably contains a vinyl polymer and can be produced by polymerizing a polymerizable monomer. As the polymerizable monomer, that having a carboxyl group and that to be used in combination with the monomer having the carboxylic group can be cited.

Concrete examples of the polymerizable monomer include a methacrylate derivative such as a methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate, an acrylate derivative such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate, and an acrylic acid and a methacrylic acid derivative such as acrylonitrile, methacrylonitrile and acrylamide.

Examples of the polymerizable monomer to be used in combination with the polymerizable monomer having carboxylic acid include styrene and a styrene derivative such as styrene, o-methylstyrene, p-methylstyrene, (α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene and p-n-dodecylstyrene, an olefin such as ethylene, propylene and isobutylene, a vinyl ester such as vinyl propionate, vinyl acetate and vinyl benzoate, a vinyl ketone such as vinyl methyl ketone, vinyl ethyl ketone and vinyl hexyl ketone, an N-vinyl compound such as N-vinylcarbazole, N-vinylindole and N-vinylpyrrolidone, and a vinyl compound such as vinylnaphthalene and vinylpyridine.

Moreover, a polymerizable monomer having an ionic dissociable group is preferably combined with the above monomer for constituting the resin. Such the monomer is one having a substituent such as, for example, a carboxyl group, a sulfonic acid group and a phosphoric acid group as the constituting group of the monomer. Concretely, acrylic acid, methacrylic acid, maleic acid, itaconic acid, cinnamic acid, fumaric acid, a maleic acid mono-alkyl ester, an itaconic acid mono-alkyl ester, styrenesulfonic acid, an allylsufosuccinic acid, 2-acrylamido-2-methylpropane sulfonic acid and acid sulfoxyethyl methacrylate can be exemplified.

Furthermore, the resin can be made to a resin having a crosslinked structure by using a multi-functional vinyl monomer such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate and a neopentyl glycol diacrylate.

In the invention, the foregoing Compound 1 or 2 can be used as the polymerization initiator for polymerization of the above polymerizable monomers. An inorganic peroxide, for example, a persulfate such as potassium per sulfate and ammonium persulfate, and hydrogen peroxide can be used together with the above-compound; among the inorganic peroxide compounds, hydrogen peroxide is preferred.

An organic polymerization initiator such as azobisaminodipropane and azobiscyanovaleric acid and its salt can also be used.

The number average (Mn) and the weight average (Mw) molecular weights of the resin constituting the toner of the invention are preferably from 1,000 to 100,000 and 2,000 to 1,000,000, respectively. The molecular weight of the resin constituting the toner can be determined by a gel osmotic chromatography or a gel permeation chromatography.

The molecular weight determination by the gel permeation chromatography, hereinafter referred to as GPC, is described below.

The determination is concretely carried out according to the following procedure. To 1 mg of the resin to be examined, 1 ml of tetrahydrofuran is added as a solvent and stirred at room temperature by a magnetic stirrer for sufficiently dissolving the resin. The resultant solution is filtered a membrane filter with a pore size of from 0.45 to 0.50 μm to prepare a sample for GPC determination. On the other hand, the measuring column of the GPC is heated by 40° C. and stabilized and tetrahydrofuran is flown at a rate of 1 ml per minute, and then 100 μl of the measuring sample having a concentration of 1 mg/ml is injected for measurement. The measuring column is preferably constituted by a combination of columns available on the market. For example, a combination of Shodex GPC KF-801, 802, 803, 804 and 807, each manufactured by Showa Denko K. K., and that of TSK gel G1000CH, G2000H, G3000H, G4000H, G5000H, G6000H, G7000H and TSK guard column can be cited. As the detector, a refractive index detector (IR detector) or a UV detector is suitably usable.

The number average molecular weight and the weight average molecular weight of the tetrahydrofuran soluble component in the resin particle are represented in terms of styrene resin-converted molecular weight. The styrene resin-converted molecular weight is calculated from a styrene calibration curve. The styrene calibration curve is prepared by measuring as to about 10 kinds of mono-dispersed polystyrene standard resin.

Colorant

Concrete colorants are shown below.

As the black colorant, for example, carbon black such as Furnace Black, Channel Black, Acetylene Black, Thermal Black and Lamp Black, and a magnetic powder such as magnetite and ferrite are usable.

Examples of the magenta or red colorant include C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178 and C. I. Pigment Red 222.

Examples of orange or yellow pigment include C. I. Pigment orange 31, C. I. Pigment orange 43, C. I. Pigment Yellow 12, C. I. Pigment Yellow 13, C. I. Pigment Yellow 14, C. I. Pigment Yellow 15, C. I. Pigment Yellow 74, C. I. Pigment Yellow 93, C. I. Pigment Yellow 94 and C. I. Pigment Yellow 138.

Pigments for green or cyan are described below.

In the invention, particularly high color reproducibility can be realized in the image formation using the toner containing a copper atom.

Pigment for cyan color containing the copper atom is described below.

As concrete examples of the colorant for cyan color containing the copper atom, the compounds represented by Formula I, II or III are cited. The colorants include a mixture of at least two kinds of these compounds. In the mixture, the ratio of number of the sulfonamide group to the sulfonic acid group is preferably from 1:1 to 5:1.

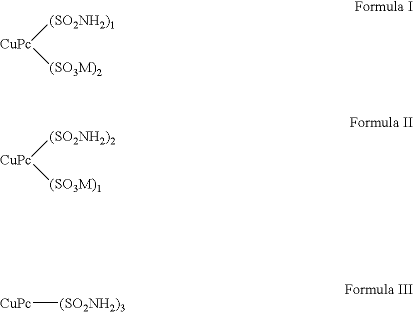

In the above, CuPc is a copper phthalocyanine ring represented by the following Formula IV.

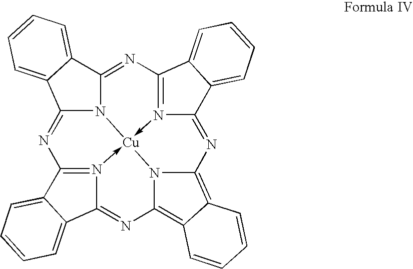

The counter ion M of the compound represented by Formula I or II is preferable a sodium ion or a lithium ion, or a quaternary ammonium ion or a quaternary phosphonium ion each represented by the following Formula V or an alkanolamine ion.

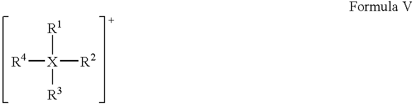

In the above formula, X is a nitrogen atom or a phosphor atom, and R₁, R₂, R₃ and R₄ are each a hydrogen atom, an alkyl group or a halogenized alkyl.

Concrete examples of compounds represented by the foregoing Formula I are shown below.

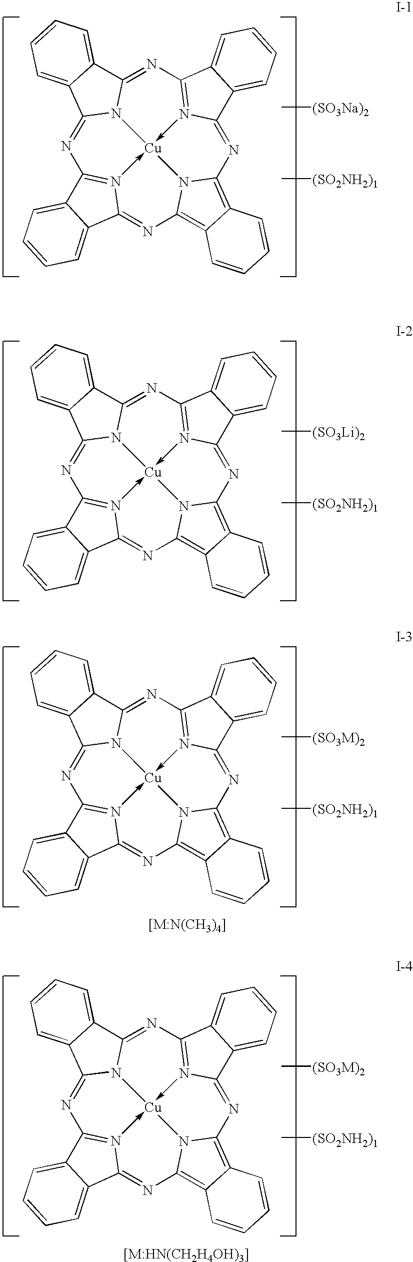

Concrete examples of copper phthalocyanine include Chromofine Blue 4920, 4927, 4920G, KBN, 4930, 4933 and 4938 each manufactured by Dainichiseika Color & Chemicals Mfg. Co., Ltd., No. 700-10 Cyanine Blue and Lionol Blue FG-7350 each manufactured by Toyo Ink Mfg. Co., Ltd., and Fastogen Blue TGR and KetBlue 104 manufactured by Dainippon Ink and Chemicals, Inc.

A β-type phthalocyanine pigment is also usable. Concretely, C. I. Pigment Blue 15:3 is preferred, and an example of the commercial product of which is Fastogen Blue TGR manufactured by Dainippon Ink and Chemicals, Inc. As a polychloro-copper-phthalocyanine pigment, C. I. Pigment Blue 7 is preferable and an example of commercial product of which is Fastogen Green S manufactured by Dainippon Ink and Chemicals, Inc. The ratio of amount of the polychloro-copper-phthalocyanine to the amount of sum of the β-type phthalocyanine pigment and the polychloro-copper-phthalocyanine pigment is preferably from 1 to 20% by weight.

As a substance capable of forming an organic ligand with the copper atom other than the phthalocyanine pigment, a copper complex of a mono- or multi-dentate ligand such as amine, phosphine, nitrile, isonitrile, carbonyl, alkene, alkine and diene can be cited.

Moreover, inorganic copper compounds are applicable.

Examples of the inorganic copper compound include Copper (II) fluoride, copper (I) chloride, copper (II) chlorate, copper (II) perchlorate, copper (I) bromide, copper (II) bromide, copper (I) iodide, copper (I) oxide, copper (II) oxide, copper (II) hydroxide, copper (II) sulfide, copper (II) sulfate, copper (I) nitrate, copper (II) nitrate, copper (II) phosphate, copper (I) carbonate, copper (II) dihydroxy carbonate, copper (I) thiocyanate, iron (III) copper (II) oxide, copper (II) hexafluorosilicate, copper (II) tetrafluoroborate, copper (II) acetate, copper (II) oxalate, copper (II) bis(2,4-pentane dionite, copper (II) bis(glycinato), copper (II) tetramine sulfate and copper (II) bis(ethylenediamine) sulfate. The above colorants are water-soluble and have high thermal resistivity and high chromaticity.

These colorants may be used singly or in combination of two or more kinds of them. The adding amount of the colorant is preferably from 1 to 30%, and more preferably from 2 to 20%, by weight of the total weight of the toner.

Chain-Transfer Agent

Usually used chain-transfer agent can be applied for controlling the molecular weight of the resin. The chain-transfer agent to be used is not specifically limited, and a mercaptan such as n-octylmercaptan, n-decylmercaptan and tert-dodecylmercaptane, a mercaptopropionate such as n-octyl 3-mercaptopropionate, terpinolene and α-methylstyrene dimer are usable for example.

Wax

As the wax to be used in the invention, known compounds are usable.

Examples of the wax include a polyolefin wax such as polyethylene wax and polypropylene wax, a long chain carbon hydride type wax such as paraffin wax and Sasol wax, a dialkyl ketone type wax such as distearyl ketone, an ester type wax such as carnauba wax, montan wax, trimethylolpropane tribehenate, pentaerythritol tetrabehenate, pentaerythritol tetrastearate, pentaerythritol diacetate dibehenate, glycerol tribehenate, 1,18-octadecanediol distearate, tristearyl tri-mellitate, and distearyl maleate, and an amide type wax such as ethylenediaminebehenylamide and trimellitic tristearylamide.

The content of the wax in the toner is preferably from 1 to 20%, and more preferably from 3 to 15%, by weight of the entire weight of the toner.

A charge controlling agent may be added to the toner of the invention according to necessity. Known compounds may be used as the charge controlling agent.

External Additive

Known inorganic fine particles are usable as the external additive. Concretely, a silica fine particle, a titania fine particle, an alumina fine particle and a composite oxide thereof can be preferably used. These fine particles are preferably to be hydrophobic.

As organic fine particles usable for the external additive, a spherical fine particle having a number average primary particle diameter of approximately from 10 to 2,000 nm can be used. As the material for constituting such the organic particle, polystyrene, polymethyl methacrylate and styrene-methyl methacrylate copolymer are applicable.

The toner of the invention can be applied for a single-component developer and a double-component developer.

When the toner is used for the single-component developer, the toner is applicable for both of a non-magnetic single-component type developer and a magnetic single-component developer prepared by adding magnetic particles having a diameter of approximately from 0.1 to 0.5 μm to the toner.

The toner can be used as the double-component developer by mixing with a carrier. As the carrier, known magnetic particles, for example, a metal such as iron, ferrite and magnetite and an alloy of such the metal and another metal such as aluminum and lead are usable. The ferrite particle is particularly preferable. The particle diameter of the carrier is preferably from 20 to 100 μm and more preferably from 25 to 80 μm.

The toner of the invention is preferably used for the non-magnetic single-component developer from the viewpoint of miniaturization of the developing device and the cost reduction.

The image forming apparatus for forming a toner image using the toner of the invention is described below.

An example of developing method is described, in which the toner of the invention is used in the form of non-magnetic single-component.

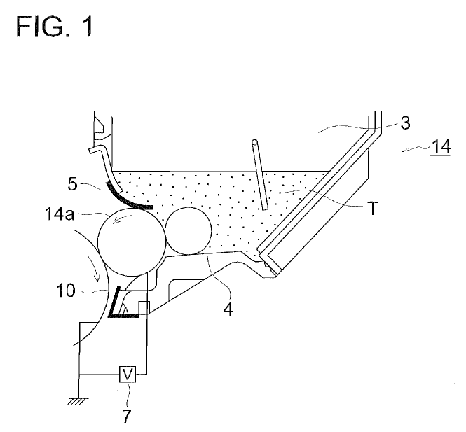

FIG. 1 shows a schematic cross section of an example of developing device for a non-magnetic single-component developer.

In FIG. 1, 14 is a developing device for using the non-magnetic single-component developer, 10 is a latent image carrier of a photoreceptor drum. The latent image is formed by an electrophotographic processing means or an electrostatic recording means which is not shown in the drawing. Symbol 14a is a developing roller which comprises a non-magnetic sleeve of aluminum or stainless steel.

The developing roller is preferably one having a surface uniformly roughened by blowing glass beads, a mirror treated surface or a surface coated with resin though the raw pipe of aluminum or stainless steel may be used without any treatment.

Toner T is stored in a hopper 3 and supplied onto a toner carrying member by a supplying roller 4. The supplying roller comprises a foamed material such as foamed polyurethane and is rotated in the same or reverse direction to the rotation direction of the toner carrying member at a relative speed for supplying the toner and simultaneously peeling off the toner remaining after development. The toner supplied onto the toner carrying member is uniformly coated as a thin layer on the carrying member by a regulation blade 5 as one kind of toner thin layer regulation member.

The touching pressure of the toner regulation blade to the toner carrying member is 3 to 250 N/m, preferably from 5 to 12 N/m, by line pressure in the sleeve direction. When the touching pressure is less than 3 N/m, the toner is difficultly coated into uniform layer and the distribution of electrostatic charge becomes broad so that fogging and scattering of the toner cause sometimes. When the touching pressure exceeds 250 N/m, not preferable phenomenon such as aggregation of the toner is caused because excessive pressure is applied to the toner so as to cause deterioration of the toner. Moreover, torque necessary for driving the toner carrying member is not preferably increased. Therefore, the aggregates of the toner of the invention can be effectively loosened and the charging amount of the toner can be instantaneously raised by controlling the touching pressure into the range of from 3 to 250 N/m.

The toner carrying member is an elastic blade or a elastic roller for which a material having a frictional electrification property in the triboelectricity series suitable for giving designated polarity of charge to the toner is preferably used.

In the invention, silicone rubber, urethane rubber and styrene-butadiene rubber are suitable. Moreover, a layer of an organic resin such as polyamide, polyimide, nylon, melamine-crosslinked nylon, phenol resin, fluororesin, silicone resin, polyester resin, urethane resin and styrene resin may be provided. Use of electroconductive rubber or electroconductive resin, and dispersing a filler or charge a controlling agent such as a metal oxide, carbon black, an inorganic whisker and an inorganic fiber into the rubber or resin of the blade are preferable for suitably charging the toner.

In the system for coating the toner thin layer on the developing roller by the blade, it is preferable to make smaller the thickness of the toner layer on the developing roller than the facing distance between the developing roller and the photoreceptor drum, and to apply an alternative electric field to thus formed space for obtaining satisfactory image density. Namely, the transfer of the toner from the developing roller onto the photoreceptor drum can be made easy so as to obtain a higher quality image by applying the alternative electric filed or alternative electric field overlapped with a direct electric current between the developing roller 14a and the photoreceptor drum 10 from a bias power source 7 in FIG. 1.

The toner of the invention is suitably used in the image forming method including a process for fixing the image by passing an image receiving material on which a toner image is formed between a heating roller and the pressing roller constituting a fixing device.

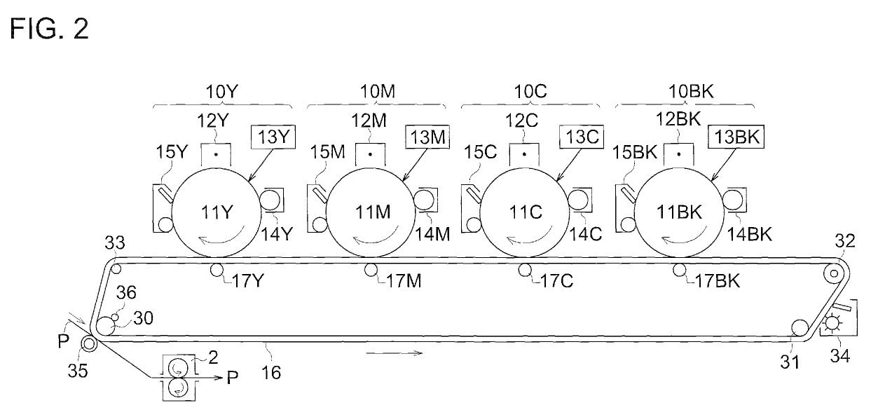

FIG. 2 is a cross section of an example of a full-color image forming apparatus for image forming by the toner of the invention.

The full-color image forming apparatus shown in FIG. 2 has units 10Y, 10M, 10C and 10K, a belt-shaped intermediate transfer member 16, transfer rollers 17Y, 17N, 17C and 17K, a belt cleaning device 34 and a fixing device 2.

The photoreceptor drums 11Y, 11M, 11C and 11Bk are each provided in the units 10Y, 10M, 10C and 10Bk, respectively. The photoreceptor drums are each clockwise rotatable in the direction shown by the arrow at a designated circumference rate (processing speed). Around the units 10Y, 10M, 10C and 10Bk, scorotron charging devices 12Y, 12M, 12C and 12Bk, exposing devices 13Y, 13M, 13C and 13Bk, developing devices for each of the colors (a yellow developing device 14Y, a developing device 14M, a cyan developing device 14C and a black developing device 14Bk) and photoreceptor cleaners 15Y, 15M, 15C and 15Bk, are arranged, respectively.

The units 10Y, 10M, 10C and 10Bk are arranged in series on the intermediate transfer belt 16, but the order of each of the unit can be suitably changed, for example, into the order of 10Bk, 10Y, 12C and 10M, according to the method of image formation.

The intermediate transfer belt 16 can be anticlockwise rotated by a backup roller 30 and support rollers 31, 32 and 33 at a circumstance rate the same as that of the photoreceptor drums 11Y, 11M, 11C and 11Bk, and is arranged so that a part of it is contacted to each of the photoreceptor drums 11Y, 11M, 11C and 11Bk at the positions between the support rollers 32 and 33. A belt cleaning device 34 is provided to the intermediate transfer belt 16. The support roller 31 functions as a tension roller and arranged so as to be capable of moving in the direction of the intermediate transfer belt 16 and the tension of the intermediate transfer belt can be controlled.

The transfer rollers 17Y, 17M, 17C and 17Bk are arranged inside of the intermediate transfer belt 16 and at the positions each facing to the portion where each of the photoreceptor drums 11Y, 11M, 11C and 11Bk are touched to the intermediate transfer belt 16 to form primary transfer portions (nipping portions) for transferring the toner image to the intermediate transfer belt 16.

A bias roller 35 is arranged on the surface side of the intermediate transfer belt 16 on which the toner image is carried so as to face to a backup roller 30 through the intermediate transfer belt. A secondary transfer portion (nipping portion) is constituted by the bias roller 35 and the backup roller 30 arranged through the intermediate transfer roller 16. A rotatable electrode roller 36 attached by pressure to the backup roller is provided on the backup roller 30.

A fixing device 2 is arranged so that an image receiving material P is conveyed into that after passing the secondary transfer portion.

In the unit 10Y shown in FIG. 2, the photoreceptor drum is driven to be rotated. At the same time, the scorotron 12Y is driven to uniformly electrify the surface of the photoreceptor drum 11Y at the designated polarity. The photoreceptor drum 11Y electrified on the surface thereof is imagewise exposed by the exposing device 13Y and a latent image is formed on the surface thereof.

The latent image is developed by the yellow developing device 14Y to form a toner image on the surface of the photoreceptor drum 11Y.

The toner images are primarily transferred successively onto the outside surface of the intermediate transfer belt 16 by an electric field formed by the transfer bias applied by the transfer roller 17Y at the time of passing the primary transfer portion between the photoreceptor drum 11Y and the intermediate transfer belt 16.

After that, the toner remaining on the photoreceptor drum 11Y is removed and cleared by the photoreceptor cleaner 15Y and then the photoreceptor drum 11Y is re-prepared to the next transferring cycle.

Such the transfer cycle is similarly performed in each of the units 10M, 10C and 10Bk and a second, third and fourth color toner images are successively formed and piled on the intermediate transfer belt 16 so as to form a full color image.

The full color toner image transferred on the intermediate transfer belt 16 is arrived at the secondary transfer portion by rotation of the intermediate transfer belt, where the bias roller 35 is provided.

The image receiving material P is supplied at designated timing to the secondary transfer portion constituted by the intermediate transfer belt 16 and the bias roller 35. The toner image carried on the intermediate transfer belt 16 is transferred onto the image receiving material P by press-contact-conveying by the bias roller 35 and the backup roller 30 and the rotation of the intermediate transfer belt 16.

After the image transfer, the image receiving material P is conveyed to the fixing device 2 and the toner image is fixed by pressing and heating treatment. The intermediate transfer belt 16 is subjected to remaining toner cleaning by the belt cleaning device 34 provided at a position in the lower course of the secondary transfer portion and made provision for the next transfer.

For the intermediate transfer belt and the endless belt of the fixing device relating to the invention, polyimide resin is preferably used as the material of the belt.

Image Receiving Material

The image receiving material P to be used in the invention is a support holding the toner image and usually called as an image supporting material, image transfer material or transfer paper. Concretely, various transfer materials such as ordinary thin or thick paper, high grade paper, coated paper for printing such as art paper and coated paper, Japanese paper and post card paper available on the market, plastic film for OHP and cloth are usable though the material is not limited to the above-mentioned.

### EXAMPLES

The embodiments of the invention are described below referring examples though the invention is not limited to them.

Preparation of Resin Particle Dispersion 1

In a separable flask on which a stirrer, a thermal sensor, a cooling pipe, a nitrogen gas introducing device were attached, Aqueous Medium 1 was prepared by dissolving 10 parts by weight (effective component content: 2.7 parts by weight) of polyoxyethylene lauryl ether sulfate sodium salt by 1510 parts by weight of deionized water. Then the mixed solution composed of the following components was added to Aqueous Medium 1.

| | |
|---|---|
| Styrene | 213 parts by weight |
| n-butyl acrylate | 62 parts by weight |
| Acrylic acid | 7 parts by weight |
| Pentaerythritol tetrastearate | 154 parts by weight |

To the resultant mixture, a initiator solution having the following composition was added and the temperature was raised by 82.5° C. and polymerizing reaction was carried out for 2 hours.

| | |
|---|---|
| Potassium persulfate | 5 parts by weight |
| n-octylmercaptan | 0.6 parts by weight |

After that, the followings were further added.

| | |
|---|---|
| Styrene | 542 parts by weight |
| n-butyl acrylate | 157 parts by weight |
| Acrylic acid | 18 parts by weight |
| n-octylmercaptan | 8.2 parts by weight |
| Hydrogen peroxide solution (effective component | 145 parts by weight |
| content: 9 parts by weight) | |
| A solution of sodium salt of Compound 2 ion | 153 parts by weight |
| (effective component content: 9 parts by weight) | |

And then 48 parts by weight of an aqueous solution of sodium salt of polyoxyethylene lauryl ether sulfate (effective component content: 23.5 parts by weight) was added. Thereafter, the temperature was raised by 90° C. and polymerization reaction was performed for 1 hour while stirring to prepare a resin particle dispersion. The dispersion was referred to as Resin Particle Dispersion 1.

Preparation of Colorant Dispersion C

An aqueous dispersion of colorant particles was prepared by dispersing cyan colorant, Lionol Blue 7334E-P-FD, manufactured by Toyo Ink Mfg. Co., Ltd., in deionized water so that the solid component concentration of the colorant becomes 12.5% by weight. Thus obtained dispersion was referred to as Colorant Dispersion C.

Preparation of Colorant Dispersion M

An aqueous dispersion of colorant particles was prepared by dispersing magenta colorant C. I. Pigment Red 122 in deionized water so that the solid component concentration of the colorant becomes 12.5% by weight. The dispersion was referred to as Colorant Dispersion M.

Preparation of Colorant Dispersion Y

An aqueous dispersion of colorant particles was prepared by dispersing yellow pigment C. I. Pigment Yellow 74 in deionized water so that the solid component concentration of the colorant becomes 12.5% by weight. The dispersion was referred to as Colorant Dispersion Y.

Preparation of Colorant Dispersion Bk

An aqueous dispersion of colorant particles was prepared by dispersing black colorant REGAL 330R, manufactured by Cabot Corporation, in deionized water so that the solid component concentration of the colorant becomes 12.5% by weight. The dispersion was referred to as Colorant Dispersion Bk.

Preparation of Toners

Preparation of Toner C

Into a separable flask, on which a thermometer, a cooling pipe, a nitrogen gas introducing device and a stirrer were attached, 1,700 parts by weight in terms of solid component of Resin Particle Dispersion 1, 2,100 parts by weight of deionized water and 2,000 parts by weight of Colorant Particle Dispersion C were charged. And then the pH of the system was adjusted to 10 by adding an aqueous solution of sodium hydroxide (25% by weight) while holding the temperature of the system at 30° C.

After that, an aqueous solution prepared by dissolving 54.3 parts by weight of magnesium chloride hexahydrate in 104.3 parts by weight of deionized water was added to the above mixture and then the temperature of the system was raised by 75° C. for beginning the coagulation reaction. After beginning the coagulation reaction, the reacting liquid was samples at periodic intervals and subjected to determination of the median diameter on particle volume base by a particle distribution measuring apparatus Multisizer 3, manufactured by Beckman-Coulter Co., Ltd. When the median particle (D₅₀) of the particle becomes 5.8 μm, 32 parts by weight of sodium citrate was added and further continuously stirred.

The coagulation reaction was completed by cooling the system by 30° C. when the sphere degree of the particle becomes 0.976 to prepare Colored Particle C1. In the Colored Particle C1, the median diameter on volume base was 5.8 μm and the variation coefficient of the particle size distribution on volume base was 18.8.

The dispersion of Colored Particle C1 was subjected to solid-liquid separation treatment by a basket type centrifugal separation machine Mark III type 60×40, manufactured by Matsumoto Kikai Seisakusho Co., Ltd., to prepare a wet cake of Colored Particle C1. Thereafter, washing and solid-liquid separation of Colored Particle C1 were repeated until the electroconductivity of the filtrate becomes 15 μS/cm.

The final wet cake of Colored Particle C1 was transferred to a air blowing drying machine Flash Jet Dryer, manufactured by Seishin Enterprise Co., Ltd., and dried until the moisture content was made to 0.5% by weight. The drying treatment was carried out by blowing air of 40° C. and 20% RH.

To dried Colored Particle C1, 1% by weight of hydrophobic silica having a number average primary particle diameter of 12 nm and a hydrophobicity of 68 and 1% by weight of hydrophobic titanium hydroxide having a number average primary particle diameter of 80 nm and a hydrophobicity of 63 were added using a Henschel mixer, manufactured by Mitsui Miike Kagaku Kogyo Co., Ltd., to prepare Toner C1.

The median diameter on volume base (D₅₀) and the variation coefficient of the particle size distribution on volume base were each the same as the foregoing values of Colored Particle C1.

Preparation of C2

Toner C2 was prepared in the same manner as in Toner 1 except that the amount of the aqueous solution of sodium salt of Compound 2 ion was increased by 2 times.

Preparation of C3

Toner C3 was prepared in the same manner as in Toner 1 except that the adding amount of the aqueous solution of sodium salt of Compound 2 ion was decreased by 0.5 times.

Preparation of C4

Toner C4 was prepared in the same manner as in Toner 1 except that adding amount the sodium salt of Compound 2 ion was replaced by 40.0 parts by weight of Compound 1.

Preparation of C5

Toner C5 was prepared in the same manner as in Toner 1 except that the adding amount of the aqueous solution of hydrogen peroxide was decreased by 0.75 times and the adding amount of the sodium salt of Compound 2 ion was increased by 4 times.

Preparation of C6

Toner C6 was prepared in the same manner as in Toner 1 except that the adding amount of the aqueous solution of hydrogen peroxide was increased by 1.35 times and the adding amount of the sodium salt of Compound 2 ion was decreased by 0.25 times.

Preparation of C7

Toner C7 was prepared in the same manner as in Toner 1 except that the adding amount of the aqueous solution of hydrogen peroxide was increased by 1.4 times and the adding amount of the sodium salt of Compound 2 ion was decreased by 0.18 times.

Preparation of C8

Toner C8 was prepared in the same manner as in Toner 1 except that the adding amount of the aqueous solution of hydrogen peroxide was decreased by 0.75 times, the adding amount of the sodium salt of Compound 2 ion was increased by 3.5 times and 22.5 parts by weight of Compound 1 was added.

Preparation of C9

Toner C9 was prepared in the same manner as in Toner 1 except that the aqueous solution of sodium salt of Compound 2 ion was replaced by an aqueous solution of sodium ascorbate.

Preparation of C10

Toner C10 was prepared in the same manner as in Toner 1 except that the adding amount of the aqueous solution of hydrogen peroxide and that of the aqueous solution of sodium ascorbate were each increased by 2.0 times.

Preparation of Toner C11

Toner C11 was prepared in the same manner as in Toner 9 except that the adding amount of the aqueous solution of hydrogen peroxide and that of the aqueous solution of sodium ascorbate were each decreased by 0.5 times.

Preparation C12

Toner C12 was prepared in the same manner as in Toner 1 except that potassium persulfate was used in place of the aqueous solution of hydrogen peroxide and sodium salt of Compound 2 ion.

These prepared Toners C1 to C12 were subjected to measurement by hydrophilic interaction chromatography.

Detection of Compound 1, Compound 2 ion and Compound 3 and determination of the total content of them were carried out as to Toners C1 to C8, and the detection of ascorbic acid, ascorbic acid ion and oxidized ascorbic acid and determination of the total content of them were carried out as to Toners C9 to C11. Toner C11 was also subjected to the examination but any of these compounds was not detected.

The detected compounds and their total content are listed in Table 1.

TABLE 1

| | | Total content |
|---|---|---|
| | | of the compounds |
| | | in the left |
| Toner No. | Detected compound | column(ppm) |
| Toner C1 | Compound 1, Compound 2 ion and | 52 |
| | Compound 3 | |
| Toner C2 | Compound 1, Compound 2 ion and | 93 |
| | Compound 3 | |
| Toner C3 | Compound 1 and Compound 3 | 31 |
| Toner C4 | Compound 1 and Compound 3 | 52 |
| Toner C5 | Compound 1, Compound 2 ion and | 139 |
| | Compound 3 | |
| Toner C6 | Compound 3 | 11 |
| Toner C7 | Compound 3 | 7 |
| Toner C8 | Compound 1, Compound 2 ion and | 155 |
| | Compound 3 | |
| Toner C9 | Ascorbic acid, ascorbic acid ion | 52 |
| | and oxidized ascorbic acid | |
| Toner C10 | Ascorbic acid, ascorbic acid ion | 93 |
| | and oxidized ascorbic acid | |
| Toner C11 | Ascorbic acid and oxidized ascorbic | 30 |
| | acid | |
| Toner C12 | — | 0 |

Preparation of Toners M1 to M12

Toners M1 to M12 were prepared in the same manner as in each of Toners C1 to C12 except that Colorant Dispersion C was replaced by Colorant Dispersion M, respectively.

Preparation of Toners Y1 to Y12

Toners Y1 to Y12 were prepared in the same manner as in each of Toners C1 to C12 except that Colorant Dispersion C was replaced by Colorant Dispersion Y, respectively.

Preparation of Toners Bk1 to Bk12

Toners Bk1 to Bk12 were prepared in the same manner as in each of Toners C1 to C12 except that Colorant Dispersion C was replaced by Colorant Dispersion Bk, respectively.

The above prepared Toners C1 to C12, Toners M1 to M12, Toners Y1 to Y12 and Toners Bk1 to Bk12 were each used as a non-magnetic single-component developer and subjected to the following evaluation in combinations as shown in Table 2. The tests using Toners C9 to C12, Toners M9 to M12, Toners Y9 to Y12 and Toners Bk9 to Bk12 are referred to as Examples 1 to 8 and that using Toners C1 to C8, Toners M1 to M8, Toners Y1 to Y8 and Toners Bk1 to Bk8 are referred to as Comparative examples 1 to 4, respectively.

Evaluation

A color laser printer available on the market, Magicolor 5430DL manufactured by Konica Minolta Business Technologies Co., Ltd., was used as the image forming apparatus for the evaluation.

When the remaining amount of the toner in the cartridge is shortened, the printing operation was stopped once and toner was additionally supplied and then the evaluation was continued.

Evaluation of Image

The image was evaluated as to the following items. In the evaluation norms, ranks A, B and C were judged as acceptable results and C was unacceptable for practical use.

Evaluation of Color Contamination

The evaluation of color contamination was sensually evaluated by each ten of male and female randomly selected panelists.

A color chart of cyan, yellow, orange, green, blue and black was printed on A4 size high grade paper having a weight of 64 g/m² by the above evaluation apparatus. The cyan printed image formed by single color toner and green and blue printed images each formed by two color toners were subjected to the color contamination evaluation by the above panelists.

Evaluation Norms

A: Eleven or more persons judged that the images seemed clear.

B: Eleven or more persons judged that the images seemed clear a little.

C: Eleven or more persons judged that the images seemed normal.

D: Eleven or more persons judged that the images seemed contaminated.

Evaluation of Chromaticity

Print images were prepared on the paper in which the toner adhering amount was controlled so as to be 0.48 mg/cm². The color space L*a*b* of each of the images was determined by a color-difference meter CM-2002 manufactured by Minolta Co., Ltd., and chroma C* was calculated by the following equation.

C*=\sqrt{a*²+b*²} Equation 1

Evaluation Norms

A: C*≧47; Excellent

B: 47 C*≧45; Good

C: 45 C*≧40; Acceptable

D: 40 C*; Unacceptable

Evaluation of Odor

The evaluation of odor was carried out by sensual evaluation by each 10 of male and female randomly selected panelists.

A chamber of 33 m² without any ventilator was conditioned at ordinary temperature and moisture (20° C., 50% RH). In the chamber, character images (character size of 10.5-point) having a image area ratio of 20% were continuously printed on 500 sheets of the A4 size high grade paper (64 g/m²) and then order in the chamber was evaluated by the above twenty panelists.

Evaluation Norms

A: Eleven or more persons judged that any odor was not felt at all.

B: Eleven or more persons judged that the order was felt when suggestion was given but they did not mind it.

C: Eleven or more persons judged that the odor was usually feeling degree.

D: Eleven or more persons judged that the odor accompanied with fixing was felt.

The evaluation results are listed in Table 2.

TABLE 2

| | | | | | Color | | |
|---|---|---|---|---|---|---|---|
| | Toner No. | | | | contamination | Odor | Chromaticity |
| Example 1 | Toner C1 | Toner M1 | Toner Y1 | Toner Bk1 | A | A | A |
| Example 2 | Toner C2 | Toner M2 | Toner Y2 | Toner Bk2 | B | A | B |
| Example 3 | Toner C3 | Toner M3 | Toner Y3 | Toner Bk3 | B | B | A |
| Example 4 | Toner C4 | Toner M4 | Toner Y4 | Toner Bk4 | A | A | A |
| Example 5 | Toner C5 | Toner M5 | Toner Y5 | Toner Bk5 | C | A | B |
| Example 6 | Toner C6 | Toner M6 | Toner Y6 | Toner Bk6 | C | C | B |
| Example 7 | Toner C7 | Toner M7 | Toner Y7 | Toner Bk7 | C | C | C |
| Example 8 | Toner C8 | Toner M8 | Toner Y8 | Toner Bk8 | C | C | C |
| Comparative | Toner C9 | Toner M9 | Toner Y9 | Toner Bk9 | D | C | D |
| example 1 | | | | | | | |
| Comparative | Toner C10 | Toner M10 | Toner Y10 | Toner Bk10 | D | B | D |
| example 2 | | | | | | | |
| Comparative | Toner C11 | Toner M11 | Toner Y11 | Toner Bk11 | C | D | C |
| example 3 | | | | | | | |
| Comparative | Toner C12 | Toner M12 | Toner Y12 | Toner Bk12 | D | D | D |
| example 4 | | | | | | | |

It is confirmed from the evaluation results shown in Table 2 that the effects of the invention are realized in Examples 1 to 8 and satisfactory results are obtained as to all the evaluation items. Besides, it is confirmed that sufficient result cannot be obtained in Comparative Example 1 to 4 in any one of the evaluation items and the effects of the invention are not realized.

1. A toner for forming an electrophotographic image comprising a vinyl resin, a colorant, and at least one kind of compound represented by a formula of Compound 1, Compound 2 ion or Compound 3.

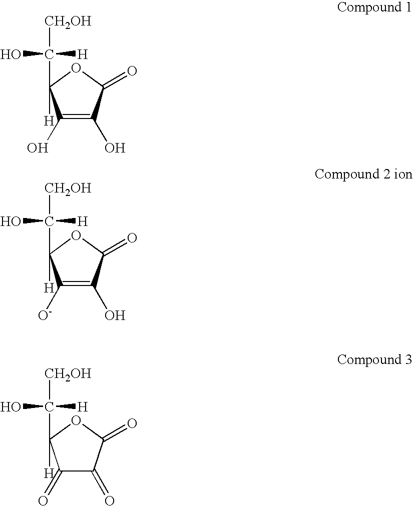

2. The toner of claim 1, wherein the total amount of the compounds of Compound 1, Compound 2 ion and Compound 3 in the toner is from 10 to 140 ppm.

3. The toner of claim 1, wherein the colorant contains a copper atom.

4. The toner of claim 3, wherein the colorant includes at least one kind of compound represented by Formula I, II or III; 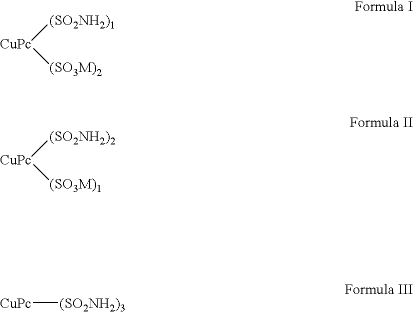
wherein CuPc is a copper phthalocyanine ring represented by Formula IV; 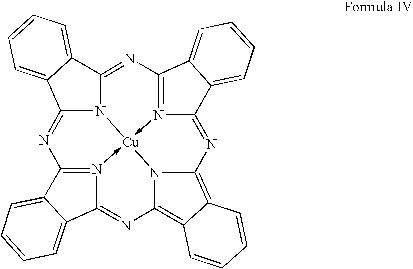
and in Formula I or II, M is a sodium ion, a potassium ion; or a quaternary ammonium ion or a quaternary phosphonium ion each represented by Formula V; or an alkanolamine ion; 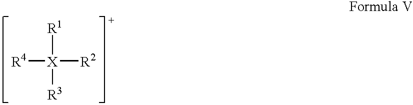
wherein X is a nitrogen atom or a phosphor atom, R₁, R₂, R₃ and R₄ are each a hydrogen atom, an alkyl group having 1 to 4 carbon atoms or a halogenized alkyl group.

5. The toner of claim 4, wherein at least two kinds of the compounds of Formula I, II and III are contained.

6. The toner of claim 4, wherein a ratio of number of —(SO₂NH₂) group to that of —(SO₃M) group is from 1:1 to 5:1.

7. The toner of claim 1, wherein median diameter (D₅₀) of toner particles on volume base of the toner is from 3 to 9 μm.

8. The toner of claim 1, wherein a variation coefficient of the particle distribution on volume base of the toner is from 8 to 21%.

9. The toner of claim 8, wherein the variation coefficient of the particle distribution on volume base of the toner is from 10 to 19%.

10. The toner of claim 1, wherein an average spherical degree of the toner particles is from 0.941 to 0.995.

11. A preparation method of toner comprising steps of;
preparing vinyl resin by polymerization, and
forming a colored particle comprising the vinyl resin and a colorant,
wherein at least one of Compound 1, Compound 2 ion and Compound 3, and an inorganic peroxide compound are used as a polymerization initiator in the polymerization.

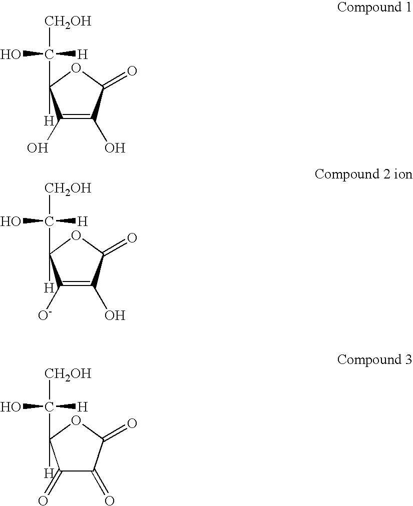

12. The method of claim 11, wherein the inorganic peroxide compound is hydrogen peroxide, potassium persulfate or potassium peroxide.

13. The method of claim 12, wherein the inorganic peroxide compound is potassium peroxide.

14. The method of claim 11, wherein the mixing ratio in mole of all of Compound 1, Compound 2 ion and Compound 3 to inorganic peroxide compound is 2 of inorganic peroxide compound to 1 to 1.2 of all of the Compound 1, Compound 2 ion and Compound 3.

15. An image forming method using the toner of claim 1.

16. The image forming method of claim 16, wherein the toner is used as a non-magnetic single-component developer.
